(19) United States
(12) Patent Application Publication
(10) Pub. No.: US 2022/0364507 A1
(43) Pub. Date: Nov. 17, 2022

(54) Turbine Comprising One or More Helical Structures and Use Thereof

(71) Applicant: Anthony Howard Lawson, Fishers, IN (US)

(72) Inventor: Anthony Howard Lawson, Fishers, IN (US)

(21) Appl. No.: 17/723,797

(22) Filed: Apr. 19, 2022

Related U.S. Application Data
(60) Provisional application No. 63/188,588, filed on May 14, 2021.

(51) Int. Cl. F02C 6/18

(52) U.S. Cl. CPC F02C 6/18

(57) ABSTRACT

The present disclosure provides a novel turbine design for converting a high-pressure fluid stream into useful energy, the turbine comprising a cylindrical housing having a fluid inlet and fluid outlets on opposing ends and being constrained by rotational bearings, with the housing containing a multi-helical structure for efficiently directing the fluid flow from the inlet to the outlets with minimal strain on the moving components. A method of use of the turbine for generating energy is also provided.

### CROSS REFERENCES TO RELATED APPLICATIONS

The present application claims the benefit and priority of U.S. provisional application No. 63/188,588, filed May 14, 2021.

### FIELD OF INVENTION

The present invention relates generally to the field of turbine structures. More specifically, the present invention relates to a turbines comprising one or more helical structures for efficiently converting a direction fluid flow to useful torque.

### BACKGROUND

A huge amount of energy production techniques rely on the conversion of high pressure fluid exhaust streams into usable energy. Many systems already exist for achieving this result efficiently, however once the fluid pressure exceeds a certain level the mechanical components of the most efficient energy conversion systems are quickly worn down. It is within this context that the present invention is provided.

### SUMMARY

The present disclosure provides a novel turbine design for converting a high-pressure fluid stream into useful energy, the turbine comprising a cylindrical housing having a fluid inlet and fluid outlets on opposing ends and being constrained by rotational bearings, with the housing containing a multi-helical structure for efficiently directing the fluid flow from the inlet to the outlets with minimal strain on the moving components. A method of use of the turbine for generating energy is also provided.

Thus, according to one aspect of the present disclosure there is provided a turbine, the turbine comprising: a cylindrical housing having a length running parallel to a central axis, wherein a first end of the cylindrical housing comprises a first rotational bearing about the circumference of the cylinder which is configured to interface with a fluid exhaust, and at least one fluid inlet configured to receive a fluid flow from a fluid exhaust, and wherein a second end of the cylindrical housing comprises a second rotational bearing about the circumference of the cylinder and which connects with a cylinder cap comprising two or more fluid outlets having openings oriented to direct expelled fluid in a direction which is orthogonal or near orthogonal to the central axis.

The turbine further comprises a plurality of hollow helical structures disposed within the cylindrical housing, the number of helical structures being equal to the number of fluid outlets of the cylinder cap, each helical structure spanning the length of the cylinder and corkscrewing about a fixed axis aligned with the central axis of the cylinder and being configured to direct a fluid flow from the at least one fluid inlet to a respective fluid outlet of the cylinder cap.

In some embodiments, the first end of the cylindrical housing is formed into a cone structure with openings in the base of the cone for fluid to flow into each helical structure and the tip of the cone ending in the fluid inlet.

The pitch of each helical structure may be directly proportional to the length of the cylindrical housing. Alternatively, the pitch of each helical structure may be set according to an intended use of the turbine.

According to another aspect of the present disclosure there is provided a method of use of the turbine of any one of above described embodiments connected to a rotor of an induction motor to convert a high-pressure directional fluid exhaust to rotational motion of the turbine to create torque and generate useful energy.

According to another aspect of the present disclosure there is provided a method of use of the turbine of any one of above described embodiments connected to a rotor of a mechanical device to convert a high-pressure directional fluid exhaust to rotational motion to create torque and generate useful energy.

### BRIEF DESCRIPTION OF THE DRAWINGS

Various embodiments of the invention are disclosed in the following detailed description and accompanying drawings.

FIG. 1A illustrates a first cutaway view of an example configuration of the turbine of the present disclosure with the internal helical structure highlighted and the outer cylindrical housing marked by dashed lines.

FIG. 1B illustrates a first isometric view of the example configuration of the turbine.

FIG. 2A illustrates a second cutaway view of the example configuration of the turbine of the present disclosure with the internal helical structure highlighted and the outer cylindrical housing marked by dashed lines.

FIG. 2B illustrates a second isometric view of the example configuration of the turbine.

FIG. 3A illustrates a third cutaway view of the example configuration of the turbine of the present disclosure with the internal helical structure highlighted and the outer cylindrical housing marked by dashed lines.

FIG. 3B illustrates a third isometric view of the example configuration of the turbine.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a novel turbine design which utilises a multi-helical internal structure to allow direction of high-pressure fluid flows received from a first angle that is parallel with a central axis and expel the fluid from outlet of the helical structure which are oriented orthogonally or near orthogonally to the central axis, creating torque.

The multi-helical structure that is used for directing the received fluid flow has the benefit of minimizing fluid velocity loss, thereby increasing efficiency, while enabling gradual directional change of the fluid direction within the turbine to spread the pressure exerted by the fluid on the components and thus reduce wear. This also means that the turbine can be manufactured using materials with less compressive or tensile strength.

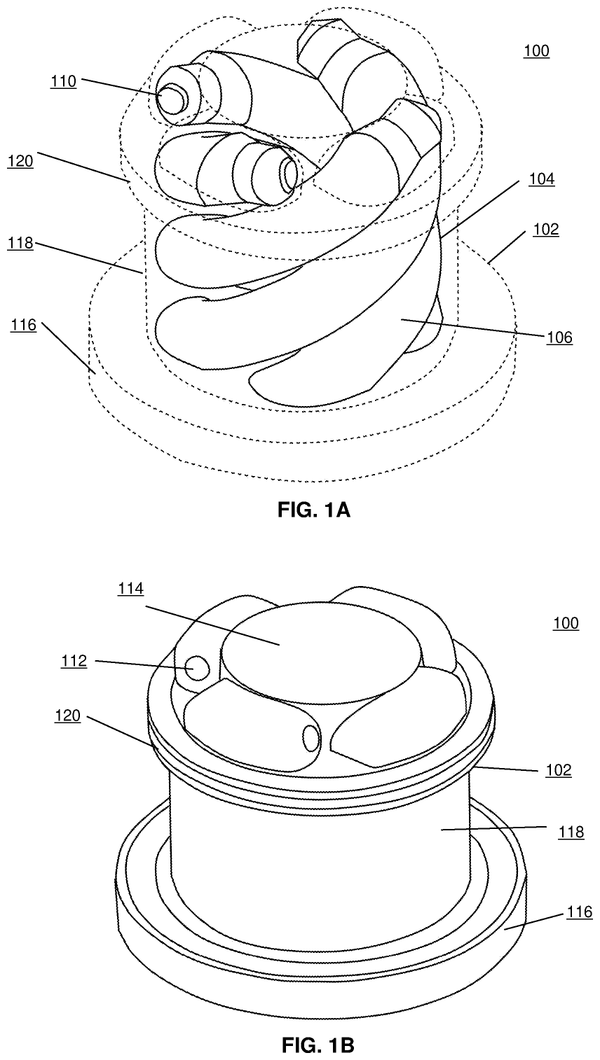

FIGS. 1A-3B illustrate various views of one example configuration of the disclosed turbine to better explain the various structural features, however the illustrated example should not be construed as limiting, other configurations making use of the same principles are also envisioned.

Thus, referring to FIG. 1A and FIG. 1B, a first cutaway and isometric view of an example configuration of the turbine 100 of the present disclosure are illustrated.

The turbine 100 is comprised of a cylindrical housing 102 (illustrated by dashed lines in FIG. 1A and fully in FIG. 1B) and a hollow multi-helical structure 104 disposed within the cylindrical housing 102 (only visible in FIG. 1A).

The helical structure 104 is comprised of two or more hollow tubes 106 disposed within the cylindrical housing 102 which span its length and corkscrew about its central axis, thus intertwining with each other to from structure 104. Each tube 106 has an open end 108 that connects with a first end of the cylindrical housing to receive a fluid flow, a length which corkscrews about the central axis of the cylindrical housing in one or more turns, and a second end that has a fluid outlet 110 such as a nozzle that is directed orthogonally or near orthogonally to the central axis about which the helix turns.

The outlets 110 of the tubes 106 will all be oriented in either a clockwise or an anti-clockwise direction with respect to the central axis, since each tube turns in the same direction as the other tubes, and each nozzle 110 will interface with an opening 112 in a cap 114 that covers the second end of the cylindrical housing.

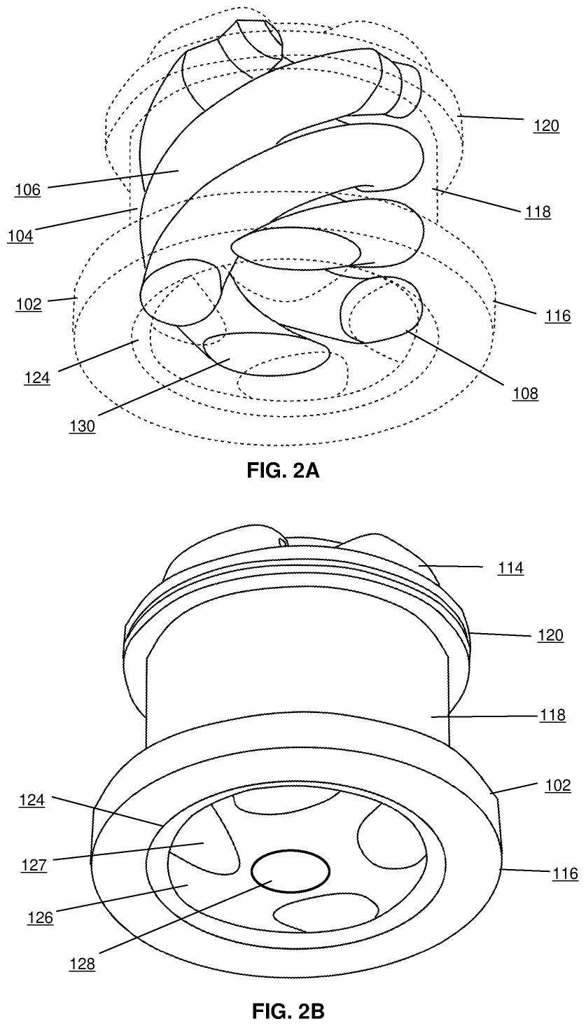

Referring to FIG. 1B, the cylindrical housing 102 has a first circular bearing 116 that surrounds the circumference of the cylinder walls 118, and which is configured to interface with an exhaust or other type of fluid outlet, connecting a fluid flow to the open ends 108 of the tubes of the helical structure 104 (see FIG. 2A and FIG. 2B) and constraining any motion of the housing 102 with respect to the connected outlet to rotational motion about the central axis of the cylinder.

The opposing end of the cylindrical housing 102 is connected to cap 114 by a second rotational bearing 120 similar in construction to the first bearing, and which constrains the cap 114 to rotate about the central axis of the cylinder with respect to the cylinder walls 118.

The cap 114 has a number of openings 112 for interfacing with the fluid outlets 110 of the helical structure 104 disposed within the housing 102, the number of openings 112 in the cap 114 is thus equal to the number of helical tubes 106 used for the helical structure 104. In the present example there are four tubes 105 and thus four openings 112, however the number may vary depending on the intended use and other specifications of the turbine 100.

Having both the first bearing 116 for interfacing with a fluid outlet/exhaust and second bearing 120 which allows the cap 114 to rotate with respect to the cylinder walls 118 reduces the amount of frictional resistance when the helical structure 104 rotates.

Referring to FIG. 2A and FIG. 2B, a second view of the turbine 100 is shown which better illustrates the interface for connecting to a fluid exhaust in this example configuration.

The interface comprises an indent 124 in the underside of the turbine and a cone-like structure 126 protruding from the indent 124 with a fluid intake opening 128 at the “peak” of the cone 126 for receiving a high-pressure fluid flow from an exhaust or other fluid outlet that the first bearing 116 is connected to. The base of the cone 126 has openings 130 for directing fluid received from an outlet into each tube 106 in the helical structure 104.

Thus, in the present example, if bearing 116 is locked onto an exhaust outlet for a high-pressure directional fluid flow (such as hydrogen gas), the fluid will enter the cone structure 126 through opening 128, spread out into the cone structure 126 from the central axis and thus enter each of the four tube openings 108 at an approximately equal flow rate. As illustrated in FIG. 2B, the structure 126 need not be perfectly conical, and may have indents or protrusions 127 for directing fluid flow to the openings 108 of the helical structure 104 more efficiently.

The fluid will then flow along the lengths of each of the four tubes 106 and be caused by their gradual curvature and the driving pressure of the fluid behind to change direction from running parallel to the central axis of the cylinder to, once the flow reaches outlets 110, being orthogonal or near orthogonal to the central axis in either a clockwise or anti-clockwise direction. The fluid will exit the nozzles 110 and thus the connected openings 112 in the cap 114 and be expelled.

The expulsion of the fluid from each of the four openings 112 will create an opposing torque in the cap 114, causing it and the entire helical structure 104 to rotate about the central axis of the cylinder which is both facilitated and constrained by bearings 116 and 120.

At this point the rotational motion can be converted into useful energy in any number of ways known to the skilled person, including but not limited to mechanical devices such as flywheels for storing kinetic energy and induction-based generators for converting the motion directly into electricity.

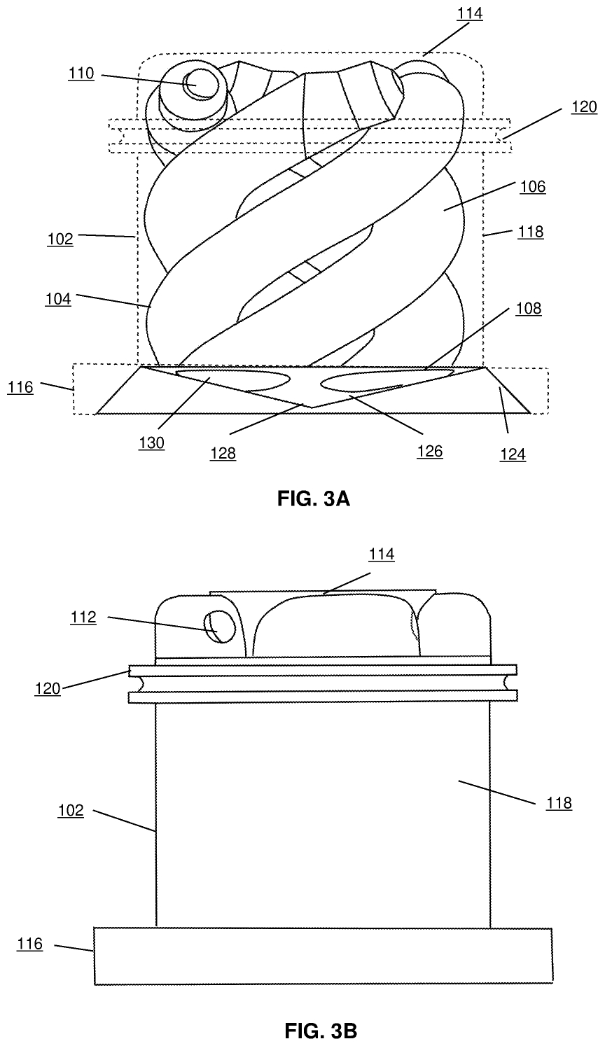

Referring to FIG. 3A and FIG. 3B, a third cutaway and isometric view is shown of the example configuration of the turbine 100 of the present disclosure.

The cone structure 126 of the fluid intake can be seen clearly in FIG. 3A, as can the spiralling arrangement of helical tubes 106. It should be noted that both the pitch and number of turns of the helix formed by each tube can be modified according to the intended use, and expected forces undergone as a result, of the turbine 100.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the turbine and methods of use have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A turbine, the turbine comprising:
a cylindrical housing having a length running parallel to a central axis, wherein a first end of the cylindrical housing comprises a first rotational bearing about the circumference of the cylinder which is configured to interface with a fluid exhaust, and at least one fluid inlet configured to receive a fluid flow from a fluid exhaust, and wherein a second end of the cylindrical housing comprises a second rotational bearing about the circumference of the cylinder and which connects with a cylinder cap comprising two or more fluid outlets having openings oriented to direct expelled fluid in a direction which is orthogonal or near orthogonal to the central axis; and
a plurality of hollow helical structures disposed within the cylindrical housing, the number of helical structures being equal to the number of fluid outlets of the cylinder cap, each helical structure spanning the length of the cylinder and corkscrewing about a fixed axis aligned with the central axis of the cylinder and being configured to direct a fluid flow from the at least one fluid inlet to a respective fluid outlet of the cylinder cap.

2. A turbine according to claim 1, wherein the first end of the cylindrical housing is formed into a cone structure with openings in the base of the cone for fluid to flow into each helical structure and the tip of the cone ending in the fluid inlet.

3. A turbine according to claim 1, wherein the pitch of each helical structure is directly proportional to the length of the cylindrical housing.

4. A turbine according to claim 1, wherein the pitch of each helical structure is set according to an intended use of the turbine.

5. Use of the turbine of any one of claims 1 to 4 connected to a rotor of an induction motor to convert a high-pressure directional fluid exhaust to rotational motion of the turbine to create torque and generate useful energy.

6. Use of the turbine of any one of claims 1 to 4 connected to a rotor of a mechanical device to convert a high-pressure directional fluid exhaust to rotational motion to create torque and generate useful energy.
